(19) United States
(12) Patent Application Publication
(10) Pub. No.: US 2004/0203685 A1
(43) Pub. Date: Oct. 14, 2004

(54) Portable communication device having a service discovery mechanism and method therefor

(76) Inventors: Ernest E. Woodward, Chandler, AZ (US); Matthew A. Hayduk, Calgary (CA); Stuart A. Harker, Calgary (CA)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/305,675

(22) Filed: Nov. 26, 2002

(51) Int. Cl. H04M 3/00; H04M 3/42

(52) U.S. Cl. 455/418; 455/414.1

(57) ABSTRACT

Briefly, in accordance with one embodiment of the invention, a portable computing or communication device includes nodes that may request a service to be performed or a server that may be able to provide the service. The nodes may include a service manager that may keep track of what services are available to that particular node.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawing in which:

FIG. 1 is a block diagram representation of a mobile device in accordance with an embodiment of the present invention; and

FIG. 2 is a logical model of a mobile device in accordance with an embodiment of the present invention.

It will be appreciated that for simplicity and clarity of illustration, elements illustrated in the figure have not necessarily been drawn to scale. For example, the dimensions of some of the elements are exaggerated relative to other elements for clarity.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

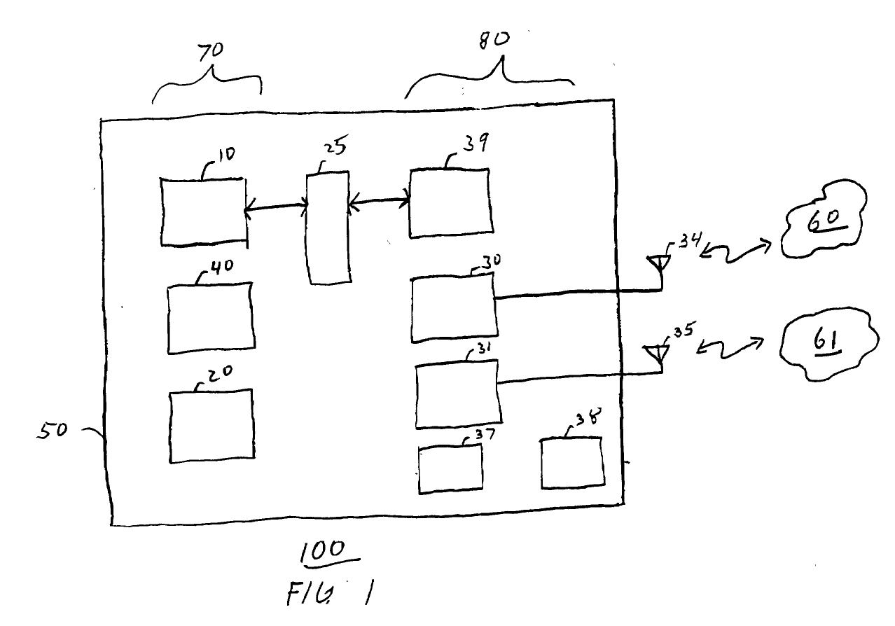

Turning to FIG. 1, an embodiment 100 in accordance with the present invention is described. Embodiment 100 may comprise a portable computing or communication device 50 such as a mobile communication device (e.g., cell phone), a two-way radio communication system, a one-way pager, a two-way pager, a personal communication system (PCS), a personal digital assistant (PDA), a portable computer, or the like. Although it should be understood that the scope and application of the present invention is in no way limited to these examples. Other embodiments of the present invention may include other computing systems that may or may not be portable or even involve communication systems such as, for example, desktop or portable computers, servers, network switching equipment, etc.

In this particular embodiment portable communication device 50 may include an application subsystem 70 and a communication subsystem 80 that are coupled together by an interface 25. Although the scope of the present invention is not limited in this respect, application subsystem 70 may be used to provide features and capabilities that are visible or used by a user such as, for example, email, calendaring, audio, video, gaming, etc. Communication subsystem 80 may be used to provide wireless and/or wired communication with other networks 60-61 such as, for example, cellular networks, wireless local area networks, etc.

An interface 25 may be used to provide communication or information between application subsystem 70 and communication subsystem 80. Although the scope of the present invention is not limited in this respect, interface 25 may comprise serial and/or parallel buses to share information along with control signal lines to be used to provide handshaking between application subsystem 70 and communication subsystem 80.

However, it should be understood that the use of interface 25 should be considered optional. In addition, the scope of the present invention is not limited so as to require both application subsystem 70 and communication subsystem 80. In alternative embodiments, a portable communication device may have just one or the other. Further, yet other embodiments may have one processor that provides the capabilities of both.

In this particular embodiment, application subsystem 70 may include a processor 10 that may execute instructions such as instructions stored in a memory 40. Processor 10 may be one of a variety of integrated circuits such as, for example, a microprocessor, a central processing unit (CPU), a digital signal processor, a microcontroller, a reduced instruction set computer (RISC), a complex instruction set computer (CISC), or the like, although the scope of the present invention is not limited by the particular design or functionality performed by processor 10. In addition, in some alternative embodiments, application subsystem 70 may comprise multiple processors that may be of the same or different type.

Portable communication device 50 may also comprise memory 40 that may comprise any variety of volatile or non-volatile memory such as any of the types of storage media recited earlier, although this list is certainly not meant to be exhaustive and the scope of the present invention is not limited in this respect. Memory 40 may be used to store sets of instructions such as instructions associated with an application program, an operating system program, a communication protocol program, etc. For example, the instructions stored in memory 40 may be used to perform wireless communications, provide security functionality for portable communication device 50, user functionality such as calendaring, email, internet browsing, etc.

Application subsystem 70 may also comprise a display 20 to provide information to a user and communication modules 30-31 to provide access to other devices, service, networks, etc. Alternatively or in addition, application subsystem may include other components such as input/output devices, audio outputs, etc. However it should be understood that the scope of the present invention is not limited so as to require any particular combination of components shown in FIG. 1.

Communication subsystem 80 may include a baseband processor 39, such as one of the types described above and communication modules 30-31 that may be used to allow portable communication device 50 to communicate with other networks through either a wired or wireless link. As shown, communication modules 30-31 may use antennae 34-35 to wirelessly communicate with networks 60-61.

Although the scope of the present invention is not limited in this respect, communication modules 30-31 may employ a variety of wireless communication protocols such as cellular (e.g. Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like).

In addition, communication modules may use other wireless local area network (WLAN), wide area network (WAN), or local area network (LAN) protocols such as the Industrial Electrical and Electronics Engineers (IEEE) 802.11 standard, Bluetooth™, infrared, etc. (Bluetooth is a registered trademark of the Bluetooth Special Interest Group).

It should be understood that the scope of the present invention is not limited by the types of, the number of, or the frequency of the communication protocols that may be used by portable communication device 50. Furthermore, alternative embodiments may not only have two communication modules (either wired or wireless) and communication modules need not have separate antennae, and some or all may share a common antenna.

It should also be understood that communication subsystem 80 may include other optional components such as, for example, a vocoder to encode voice data or memory 38. Memory 38 may comprise one or more of the memory types described above.

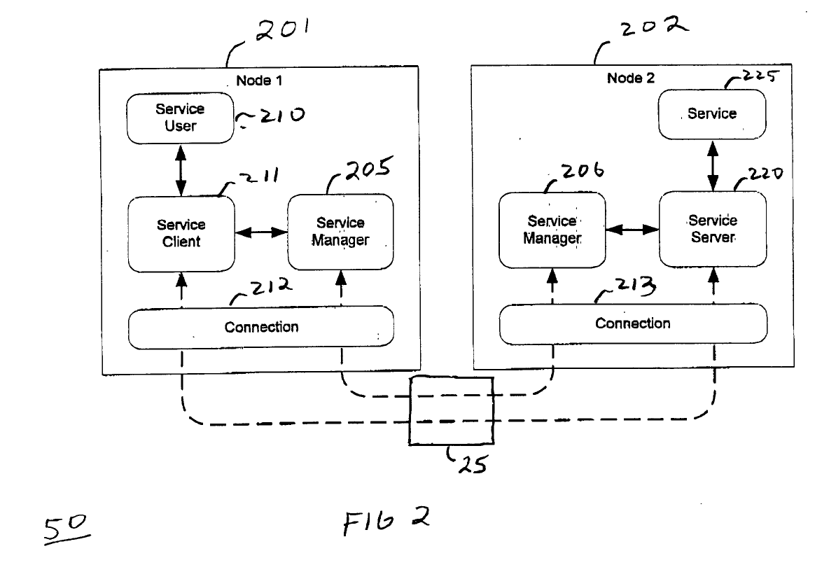

Turning to FIG. 2, a particular embodiment of the present invention is provided. FIG. 2 is a logical model diagram representing the relationships and interactions between operations that may take place within portable communication device 50. It should be understood that the operations illustrated may be implemented with any combination of hardware and software. In other embodiments, operations shown in FIG. 2 and/or discussed below may be implemented entirely in hardware or entirely in software. Furthermore, the portions of the operations that are implemented, at least in part, with software may be implemented through an operating system, user applications, firmware, etc., although the scope of the present invention is not limited to just these examples.

As shown, portable communication device 50 may include node 201-202. Simply stated, a node may represent any portion of a component within portable communication device 50. For example, although the scope of the present invention is not limited in this respect, a node may represent a portion of a core of processor 10 or 39, a portion of display 20, a portion of vocoder 37, etc. It should be understood that at least some of the components shown in FIG. 1. may provide more than one node. For example, processor 10 may have one node provided by a digital signal processor component and another provided by a core being used for the execution of user applications. The scope of the present invention is not limited by the number of nodes in portable communication device 50 or the number of nodes provided by a component of portable communication device 50.

In alternative embodiments, nodes may be provided by a combination of components such as a processor core and other components that could include a display, vocoder or other cores; a logical separation of a single processing core through an instruction set; a physical separation of processing cores connected through wireless or other logical interfaces; or any other functional component for computing and communications, and nodes are capable of instruction set execution.

Although the scope of the present invention is not limited in this respect, a node may be provided by any combination of hardware and software that provides a feature or operation of portable communication device 50. Nodes 201-202 may include a service manager 205-206. Service managers 205-206 may be used to keep track of what services (e.g. service 225) that are available to nodes 201-202, respectively. Service managers 205-206 may generate maps of the capabilities or services that are available within portable communication device 50.

Examples of capabilities or services 225 may include, but are not limited to wireless transmission, image processing, encryption, error code correction, audio encoding, image displaying, etc. Other services that may be provided include GPS, position location, diagnostics, operations, administrations, maintenance, file systems, databases, speech capture and recording, speech recognition, video capture, or any other functional capability one node could provide that another node may require to use.

Service manager 205 may maintain a list of the services or capabilities that may be available to a service user 210 and a client 211 in node 201. Although the scope of the present invention is not limited in this respect, service user 210 may represent an application executing within portable communication device 50 (i.e. on processors 10 and or 39). Further, service user 210 need not be provided exclusively by software instructions. In alternative embodiments, service user 210 may be any combination of hardware, software, firmware, bios, etc. Examples of service user 210 may include user applications such as, for example, email, SMS, EMS, FAX, MMS, Java MIDlets via the Java configuration, web browsers, file systems, telephony applications, internet networking applications, file transfer services, transport connection services, security processing services, video-teleconferencing, etc.

During the execution or operation of service user 210, service user 210 relies on the facilities of service clients, such as a service client 211 in node 210. Service client 211 may be any combination of hardware, software, firmware, bios, etc. Simply stated, service client 211 may represent the functional portion of an application that involves the use of one of the services or capabilities within portable communication device 50. For example, service client 211 may represent a routine being executed that has requested a particular piece of data be wirelessly transmitted, although the scope of the present invention is not limited in this respect.

In alternative embodiments, service clients may include cellular clients, audio clients, diagnostic clients, management clients, Bluetooth™ clients, WLAN clients, GPS clients, position location clients, database clients, file server clients, MMS clients, etc.

Service manager 205 and service client 211 may provide discovery to service user 210 by keeping track of what services are available within portable communication device 50, although the scope of the present invention is not limited in this respect. The discovery may be provided by having service manager 205 keep track of what services, capabilities, etc. are available with other nodes in portable communication device 50. For example, service manager 205 may keep track that node 202 includes the ability to wirelessly transmit information. Since service manager 205 keeps track of this information, service user 210 and service client 211 do not need to do so. This may provide an advantage in particular embodiments, because then service manager 205 can dynamically keep track of what services are available, although the scope of the present invention is not limited in this respect. For example, as a user moves with portable communication device 50, different services may be come available while other are lost.

Nodes 201 and 202 may also include a connection manager 212-213 that may maintain information as to how the nodes may communicate with the other nodes and how to exchange information. For example, connection manager 212 in node 201 may record that node 202 may be accessed through buses (dashed lines) and interface 25.

Node 202 may include a server, or service server 220, that may be capable for providing one or more services (e.g. service 225) such as one or more of the services listed above. Server 225 may refer to any combination of hardware and software that provides a capability that may be shared with other nodes. Although FIG. 2 illustrates that nodes 201-202 include either clients or servers, it should be understood that the scope of the present invention is not limited in this respect. In alternative embodiments a node may include both clients and servers. Further, a node may have multiple clients or servers.

When a server (e.g. service server 220) is able to provide a capability or service (e.g. service 225) it may inform the service manager of its node as to the availability. The service manager (e.g. service manager 206) may then generate or update its map or services to keep track of the availability of the service to any clients within that node (e.g. node 202).

The service manager may then update or inform the service managers in the other nodes (e.g. node 201) within portable communication device 50. This may be done in a variety of ways. For example, service manager 206 of node 202 may send the information to service manager 205 of node 211 using the connection information provided by connection manager 213. Service manager 205 may then update its own map of services to include the services of node 202. Service manager 205 may then act as a “Master service manager” by sending a broadcast message to the other nodes (not shown) within portable communication device 50. In this particular embodiment, service manager 205 may include the capability of knowing which other nodes in portable communication device 50 would be interested in the service 225 available by node 202. Thus, service manager 205 may send a message to all nodes, or alternatively, just those that have a need or interest in knowing. Alternatively, service manager 206 of node 202 may send a broadcast message directly to the other nodes in portable communication device 50.

When a service client 211 has a request or a need for a service (e.g. service 225), it may query service manager 205 to determine if that particular service is available within portable communication device 50. If the service is available, service client 211 may work with connection manager 212 and service manager 205 to enable use of that service. In addition, Service manager 205 and service client 211 may provide transparency of the service 225 by allowing the query of service manager 205 to locate the service across different physical implementations of the same service or to replicate the service for improved performance or reliability.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A mobile communication device, comprising:
a first node having a client and a service manager, wherein the service manager is adapted to generate a map of services within the mobile communication device that are available to the first node; and
a second node having a server and a service manager, wherein the service manager is adapted to generate a map of services within the mobile communication device that are available to the second node.

2. The mobile communication device of claim 1, further comprising a bus to couple the first node to the second node.

3. The mobile communication device of claim 2, further comprising an interface coupled to the first node and the second node by the bus.

4. The mobile communication device of claim 1, wherein the client of the first node comprises a set of instructions executing on a processor in the mobile communication device.

5. The mobile communication device of claim 1, further comprising a service user that generates requests for services that are available within the mobile communication device.

6. The mobile communication device of claim 5, wherein the service user comprises a set of instructions.

7. The mobile communication device of claim 6, wherein the set of instructions are at least a part of a user application executed on a processor of the mobile communication device.

8. The mobile communication device of claim 1, wherein the first node further comprises a connection manager.

9. The mobile communication device of claim 1, wherein the first node further comprises a server.

10. The mobile communication device of claim 1, wherein the server is adapted to provide a service selected from the group comprising: wireless transmission, image processing, encryption, error code correction, audio encoding, and image displaying.

11. The mobile communication device of claim 1, wherein the first node is provided by a core portion of an application processor of the mobile communication device.

12. The mobile communication device of claim 11, wherein the second node is provided by a base band processor of the mobile communication device.

13. A method of generating a map of services available to a node in a portable computing device, comprising:
updating a service manager in a first node of a service available from a server in a second node.

14. The method of claim 13, further comprising updating a service manager in the second node of the service that is available from the server in the second node.

15. The method of claim 13, wherein updating the service manager includes providing information regarding the service available from the server in the second node via a bus.

16. The method of claim 15, wherein updating the service manager includes providing information regarding the service available from the server in the second node to an interface between the first node and the second node.

17. The method of claim 13, further comprising updating a service manager in a third node of the service available from the server in the second node.

18. The method of claim 17, wherein updating the service manager in the third node includes updating the service manger with a communication from the first node to the third node.

19. The method of claim 17, wherein updating the service manager in the third node includes updating the service manger with a communication from the second node to the third node.

20. The method of claim 13, further comprising generating a map of services available to a client in the first node.

21. The method of claim 20, further comprising requesting a service with the client in the first node to be performed by the server.

22. An article comprising a storage medium having stored thereon instructions, that, when executed by a computing platform, results in:
updating a service manager in a first node of a service available from a server in a second node.

23. The article of claim 22, wherein the instructions, when executed, further result in:
updating a service manager in the second node of the service that is available from the server in the second node.

24. The article of claim 22, wherein updating the service manager includes providing information regarding the service available from the server in the second node via a bus.

25. The article of claim 22, wherein the instructions, when executed, further result in:
generating a map of services available to a client in the first node.
